(19) United States
(12) Patent Application Publication
(10) Pub. No.: US 2014/0052718 A1
(43) Pub. Date: Feb. 20, 2014

(54) SOCIAL RELEVANCE TO INFER INFORMATION ABOUT POINTS OF INTEREST

(71) Applicants: Roman Waupotitsch, Redmond, WA (US); Sadi Khan, Seattle, WA (US)

(72) Inventors: Roman Waupotitsch, Redmond, WA (US); Sadi Khan, Seattle, WA (US)

(73) Assignee: Microsoft Corporation, Redmond, WA (US)

(21) Appl. No.: 13/589,181

(22) Filed: Aug. 20, 2012

(51) Int. Cl. G06F 17/30

(52) U.S. Cl. 707/728; 707/E17.014

(57) ABSTRACT

Architecture that facilitates relevance analysis for user queries for items of interest (e.g., businesses) for which social relevance (the composition of people frequenting the business) of the environment. The social relevance can be determined based on social data related to other people using techniques such as cross referencing social distance, social network activities with geolocation and check-in data, time/date information associated with social content, and text mining to inform and validate conclusions. The social relevance of many users and historical trends of the data can be combined to compute scores for the items of interest. Additionally, the social relevance of persons currently visiting the business can be used to compute a current score. Predictions can be computed for specific points in time in the future. The techniques can augment, filter, and/or add “coolness” information to search results, within a general purpose, a local-oriented search page or an application.

### BACKGROUND

The amount of information being generated and accumulated on networks can serve many useful purposes if techniques for extracting the desired information are performant (efficient) and effective. The ability to obtain the desired data from this sheer amount of information as well as updates to this information needs to be more focused for the user search queries. Existing solutions attempt to address the problem through page views of webpages, click-through events on search results, or measurements of the number of people associated with the item, such as a restaurant. However, systems still need more focused and relevant search results.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

To that end, the disclosed architecture facilitates improved relevance for user queries (e.g., for business) for items (points, locations) of interest based on characteristics and/or input of people who are familiar with the item of interest, or whose opinions can be valued even if not intimately familiar with the item of interest. The architecture can apply to items of interest such as businesses for which social relevance (the composition of people frequenting the business) of the business environment is desired, as obtained from other people.

The architecture utilizes social relevance, which is social information such as utilized from data that includes other people, postings of other people on the Internet or otherwise, the information that can be derived from the postings, and the type of individuals in a person's circle (relationships), for example, to measure how interesting the item of interest (e.g., a place, business) may be. For example, with respect to locations (e.g., businesses), inferences can be derived and validated from type-of-people information of the people who frequent a type of location or specific locations, and at certain times or certain dates.

The social relevance can be determined using techniques such as cross referencing social distance, social network activities with or without geolocation (geographical location) and check-in data, time/date information associated with social content, and text mining to inform and validate conclusions.

The social relevance of many users and historical trends of the data can be combined to compute scores for the items of interest (e.g., businesses). Additionally, the social relevance of persons currently visiting the business, for example, can be used to compute a current score. Predictions can be computed for specific points in time, and in the future (e.g., today at 10 pm, each Friday, etc.).

The aforementioned techniques can be used to augment, filter, and/or add “coolness” (or trendy) information to search results, for example, within a general purpose, a local-oriented search page or an application specifically targeted for businesses in a certain category or set of categories.

The social relevance data can be obtained or derived from an external social network, the combined computed social relevance from multiple networks, the combined social relevance with another measure, and/or based on constraints that limit the relevance computation to friends in a user's social circle, for example.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative representation of a system that employs a relevance engine in accordance with the disclosed architecture.

FIG. 3 illustrates a screenshot of an application that is specific to determining “Eat & Drink” places.

FIG. 4 illustrates a method in accordance with the disclosed architecture.

FIG. 5 illustrates an alternative method in accordance with the disclosed architecture.

FIG. 6 illustrates a block diagram of a computing system that can utilize social relevance to infer information about points of interest in accordance with the disclosed architecture.

### DETAILED DESCRIPTION

Ranking results of places in an order that is relevant to a user is a challenging task. Many heuristics exist, but few have proven to be satisfactory. Social relevance addresses this need.

The disclosed architecture facilitates improved relevance for user queries (e.g., business) for items of interest, and especially for items of interest that are businesses for which social relevance (the composition of people frequenting the business) of the environment is desired. Social relevance, which is social information such as postings, is information that can be derived from the postings and the type of individuals in a person's circle to measure how interesting the item of interest (e.g., a place) may be to potential customers. For example, inferences can be derived and validated from type-of-persons information about a type of location or specific locations, and at certain times or certain dates.

The social relevance can be determined using techniques such as cross referencing social distance, social network activities with or without geolocation and check-in data, time/date information associated with social content, and text mining to inform and validate conclusions. The social relevance of many users and historical trends of the data can be combined to compute scores for the items of interest (e.g., businesses). Additionally, the social relevance of persons currently visiting the business, for example, can be used to compute a current (relevance) score. Predictions can be computed for specific points in time, and in the future (e.g., today at 10 pm, each Friday, etc.).

The aforementioned techniques can be used to augment, filter, and/or add “coolness” (or trendy) information to search results, for example, within a general purpose, a local-oriented search page or an application specifically targeted for businesses in a certain category or set of categories. The social relevance data can be obtained or derived from an external social network, the combined computed social relevance from multiple networks, the combined social relevance with another measure, and/or based on constraints that limit the relevance computation to friends in a user's social circle, for example. The term “friends” encompasses not only virtual contacts or relationships established through websites and networks such as social and professional networks, but also face-to-face contacts. This also includes relationships established according to various levels such as mere acquaintances, close acquaintances, general family, work contact(s), immediate family member(s), most trusted contacts, parents, and so on.

The measure of social relevance may be different, depending on the type of item (e.g., place) which is the subject of the query. In one implementation the measure can be based on combining check-in information (e.g., at businesses, location of interest, logins, etc.) provided by one social network with another social network site's social graph, to create a measure for social relevance.

By way of example, in the case of a query for “hot” (currently popular) clubs, check-in information can be combined with the number of friends of the persons checking-in to the establishment. Being surrounded by social people is a factor when choosing a business such as a bar or restaurant; accordingly, using social relevance as a measure is reasonable. Alternatively, or in combination therewith, the check-in information can be combined with global information that is socially relevant (e.g., guy/girl ratio for clubs, number of people with similar interests (tastes), etc.). Moreover, the disclosed architecture can process information to result in a social environment for those users of similar interests, rather than using social relevance information upfront to infer information about a point of interest.

To get the desired information for social relevance of a business, for example, one implementation combines the check-in information provided by one social network with another social network website's social graph to create a measure for social relevance.

If the two websites are different, conflation can be used to correlate check-in identity of the one website with the identity of the other website. Name, email address, and miscellaneous other information can be used to perform this correlation. If the two websites are identical, conflation is not required.

The social network websites can periodically push information to the application domain (e.g., a search engine or application provider), or the search engine or application provider can periodically poll information from the website.

Social relevance can be computed using the number of friends, for example, in the person's social circle. A refinement can be to remove friends that do not typically count as relations that contribute as a relevant signal for social relevance, such as, parents, siblings, children, ex-spouse, etc. Whether this is necessary can be empirically determined. Another refinement considers only friends with which the person has frequent interactions. In still another implementation, global information and common interests information can be utilized to determine social relevance (e.g., to initiate a conversation).

An alternative (or additional way) of measuring social relevance can be determined by wall (or similar) postings of customers of a business, where relevance can be the number of postings, the content of the postings (e.g., as determined by keywords found in the postings), the tone of the postings (e.g., positive versus negative), the replies to the posting (here also, the number of replies, keywords, tone, etc.), and socially-integrated review websites.

Two or more measures can be combined. Since the information is only statistical in nature, complete accuracy is not required, which means that a small error in conflation or the computation of social relevance will not negatively impact the system.

Social relevance can then be combined to influence the ranking of items (e.g., places) on a search engine or social relevance can drive an independent experience for places (e.g., restaurant applications, bar applications, travel destination applications, etc.) that solely (or mostly) relies on social relevance for the user experience.

Similarly, a travel application experience can employ similar logic to filter to destinations that are more popular for people traveling with friends versus traveling with family, etc.

In an extension of determining a general notion of whether a place is a good “fit” (meets user requirements), statements can be made about whether a place (or item) is a fit right now, or whether a place meets the user requirements at some point at a future date (e.g., “Mondays”, “Thanksgiving”, “on the day of my birthday”, etc.) and time. Predictions can be made of the form “for this specific place, what is the ‘hot’ time to be there”, or hot time periods can be reported with any place (e.g., to restaurants, travel, etc.). Alternatively, recommendations can be made to not visit a point of interest because it is socially unacceptable to go there (e.g., the same set of people went to this restaurant to celebrate a birthday and were dissatisfied with the accommodations).

For these type of predictions of the future, date/time (-slice) specific information can be observed and analyzed. For example, rather than looking at aggregate social relevance for a place (or item), this information can be time-sliced (e.g., using the date/time stamp of check-ins).

Alternative measures include using the social graph. The information derived from a social circle can be used as a filter for results on search pages. For example, a popular query for local businesses is “kids friendly” (is the business environment conducive to visitation by children). This typically uses self-declared information by business owners, information provided by visitors, and/or can be found in user reviews. However, the information of persons that check into a restaurant or are writing reviews can be used as an indicator. For example, if a large portion of these people have declared that they have kids on their social network website, this information can be used as an indicator for a kids-friendly place.

Similarly, if a large portion of the visitors of a bar are not-married and in a specific age range, this information can be used as an indicator that this is a good place to party.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

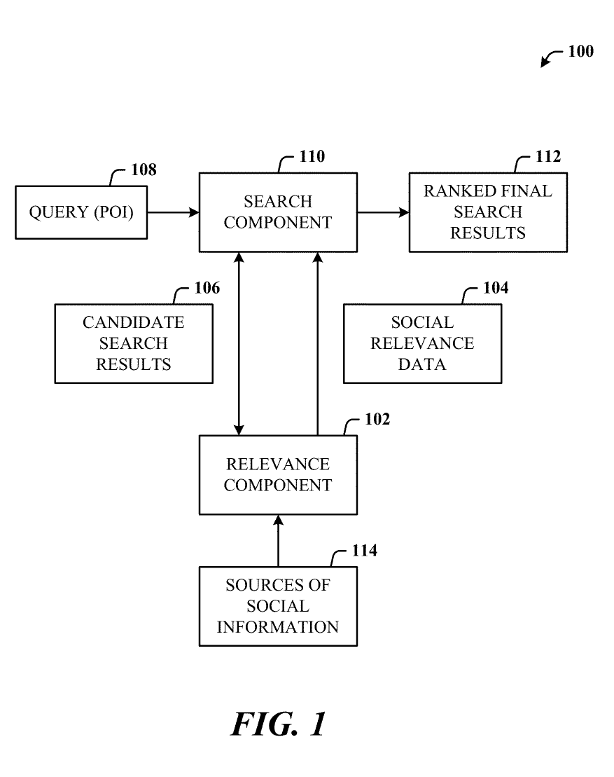

FIG. 1 illustrates a system 100 in accordance with the disclosed architecture. The system 100 can include a relevance component 102 that computes relevance of a point of interest (POI) (e.g., a business, event, item, etc.) based on social relevance data 104 derived from analysis of one or more people having an association with the point of interest. The POI is derived from a query 108 that is submitted to a search component 110 (e.g., a search engine). The POI can be part of candidate search results 106 that are returned, filtered, and ranked (by the search component 110) for further processing with the social relevance data 104 to output the ranked final search results 112 based in part on the social relevance data 104.

The social relevance data 104 is computed based on sources 114 of social information. The sources 114 can include, but are not limited to, user profiles, social networks (e.g., Facebook™), online reviews related to the POI, postings on the website of the POI, content of the postings, trend data, comments of other users on other networks, and so on. The candidate search results 106 are filtered and ranked (e.g., via the search component 110) to obtain the ranked final search results 112 based in part on the social relevance data 104.

The social relevance data 104 can be computed based on analysis of user postings of the one or more people, content of the postings, and type of people socially related to a user. The postings can be obtained from the website of the point of interest, social networks, or the like. The relevance can be computed based on an aggregation of the social relevance data of each of multiple people having visited or currently visiting the point of interest.

The social relevance data 104 can be validated based on cross-referencing of physical distance data that includes at least one of geolocation data (e.g., latitude, longitude, street data, etc.), check-in data (e.g., at a business, event, etc.), temporal data (e.g., date, time, etc.), or data (text) mining of stored data or textual sources (e.g., messaging, email, calendar or other types of scheduling information, etc.). Thus, matching can be performed between unstructured email content and structured directory listings of the points of interest. The social relevance data 104 can be employed to make a prediction of an event that will occur at a point in time (in the future, such as a day next week, today at 10 PM, etc.).

The social relevance data 104 can be processed to augment a final search result with information. The additional data can be coolness (popularity) information. The relevance component 102 can be configured to restrict computation of the social relevance data 104 to only friends (e.g., in a social circle) of a user and/or computation of the social relevance data to determine new friends of the user. The social relevance data 104 can be processed in combination with another measure of relevance to rank (facilitate ranking) the candidate search results 106. The social relevance data 104 can be computed as combined relevances (relevance data) obtained from other networks. That is, relevance-type information obtained from other networks can be combined with the relevance information in a suitable manner to assist the search component 110 in computing the final search results 112. The social relevance data 104 can be obtained from an external social network (e.g., MySpace™).

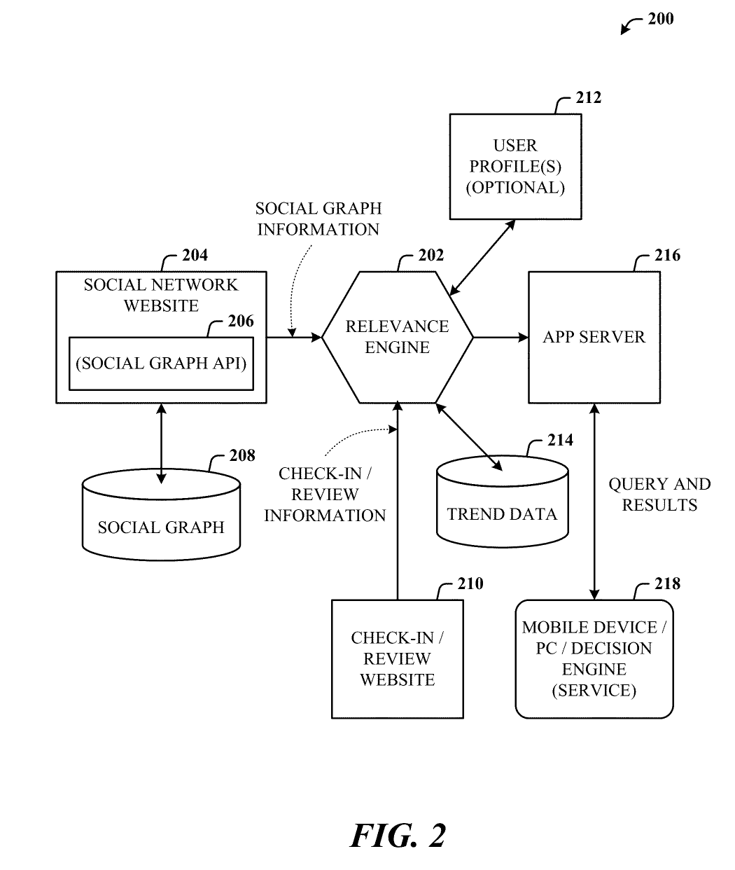

FIG. 2 illustrates an alternative representation of a system 200 that employs a relevance engine 202 in accordance with the disclosed architecture. The relevance engine 202, similar to the relevance component 102, obtains social graph information from one or more social network websites, such as a social website 204. The social website 204 includes a social graph API (application program interface) 206 suitable for interfacing to a social graph 208. Thus, each social website may include an API suitable for interfacing to its associated social graph.

The relevance engine 202 also receives check-in data and/or review information from a check-in website and/or review website 210. Check-in can be determined by geographical coordinates of the user matching the coordinates of the POI, for example. Alternatively, a wireless communication can be automatically performed once the user enters the POI, the user manually sends a message indicating presence at the POI, and/or the user makes a program selection indicating the user is at the POI, and so on. Other techniques can also be employed that ultimately indicate the user is at or arrival is imminent to the POI.

The relevance engine 202 can also access user profile information 212, as an optional input for relevance processing. The relevance engine 202 can also access trend data 214 developed from any one or more data inputs. For example, trend data can be computed that indicates a user, friends of the user, and/or users with similar preferences typically frequent the POI.

The output of the relevance engine 202 can be to an application server (App Server) 216, which provides applications with services such as data services, load balancing, etc. In this case, the applications server 216 provides at least data services in the form of the query and the results to entities 218 such as a mobile device (e.g., cell phone), computers (PC) and/or a decision engine.

The relevance engine 202 can either be located within the social network website, within the checking website, and/or can be an independent entity. For example, the independent entity can be a social networking technology such as Facebook, a check-in technology and, the relevance engine 202 and applications server 216 being a search engine.

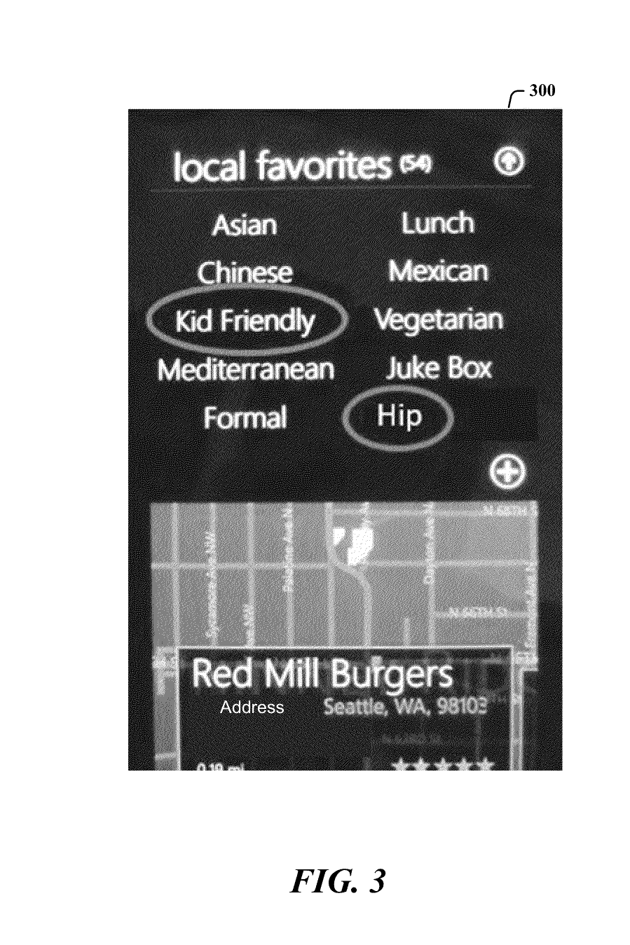

FIG. 3 illustrates a screenshot 300 of an application that is specific to determining “Eat & Drink” places. The point of interest “Red Mill Burgers” is being shown to be “kid friendly” and “hip”, as indicated by descriptors in the screenshot 300 user interface. The descriptors have been determined from input from other people who have visited, are currently visiting, or know of other people who have an opinion on the business (perhaps from others who have visited). The likely set of people who have been analyzed as to relevance of this business search result shows that they have kids and/or many of their friends have kids, and that customers follow children related discussion groups, etc. For “hip” places, the application shows places that are frequented by customers that have large social networks, are avid posters, and are “liked” (a social network preference selection, followed), etc.

The disclosed architecture can further employ a security component (not shown) for authorized and secure handling of user information. The security component allows the subscriber to opt-in and opt-out of tracking information as well as personal information that may have been obtained at signup and utilized thereafter. The subscriber can be provided with notice of the collection of personal information, for example, and the opportunity to provide or deny consent to do so. Consent can take several forms. Opt-in consent imposes on the subscriber to take an affirmative action before the data is collected. Alternatively, opt-out consent imposes on the subscriber to take an affirmative action to prevent the collection of data before that data is collected. This is similar to implied consent in that by doing nothing, the subscriber allows the data collection after having been adequately informed.

The security component also enables the user to access and update profile information. For example, the user can view the personal and/or tracking data that has been collected, and provide corrections. Where sensitive personal information such as health and financial information can be tracked and obtained during subscription or thereafter, the security component ensures that the data is housed using security measures appropriate for the sensitivity of the data. Moreover, vendor access to such information can be restricted using the security component for access only to authorized viewers.

Generally, the security component ensures the proper collection, storage, and access to the user information while allowing for the selection and presentation of content, features, and/or services that assist the user to obtain the benefits of a richer user experience and to access to more relevant information.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

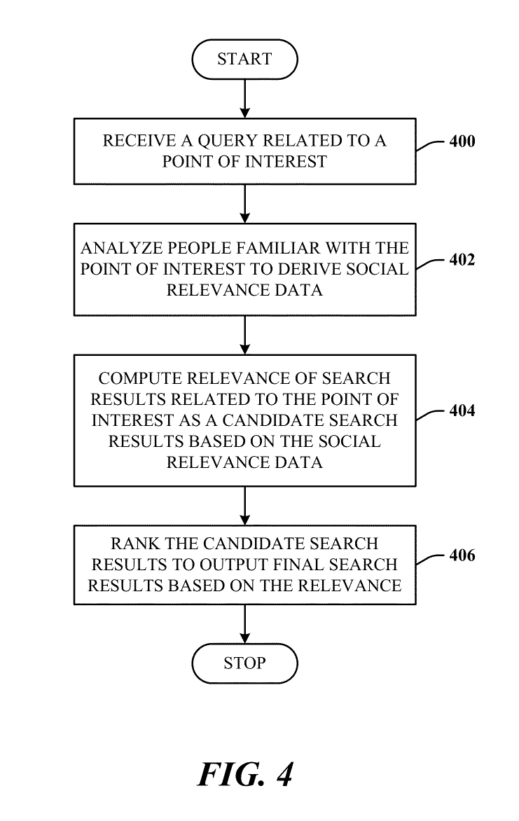

FIG. 4 illustrates a method in accordance with the disclosed architecture. At 400, a query related to a point of interest is received (e.g., in a search engine). At 402, people familiar (e.g., have visited in the past, are visiting now, know of someone who has visited and has an opinion thereof, etc.) with the point of interest are analyzed to derive social relevance data. The social relevance data can include user profiles (e.g., age, gender, preferences, etc.), a user, friends of a user, trend data, website postings, content of the postings, reviews, and so on. At 404, relevance of search results related to the point of interest as candidate search results is computed based on the social relevance data. The candidate search results can be generated and provided by a search engine. At 406, the candidate search results are ranked to output final search results based on the social relevance data. The results may be computed to be less relevant (lower relevancy scores) than more relevant results (higher relevancy scores).

The method can further comprise computing the social relevance data based on postings (e.g., information entered by users into websites as review, comments, etc.) related to the point of interest, content of the postings, and type of people. The method can further comprise computing the social relevance data as an aggregation of the social relevance data of each of multiple users visiting the point of interest. The method can further comprise validating the social relevance data based on cross-referencing of physical distance data that includes at least one of geolocation data, check-in data, temporal data, or text mining. The method can further comprise processing the social relevance data in combination with another measure of relevance to rank the candidate search results, and computing the social relevance data as combined relevance information obtained from other networks. The method can further comprise obtaining the social relevance data from an external network (e.g., a social network such as Facebook).

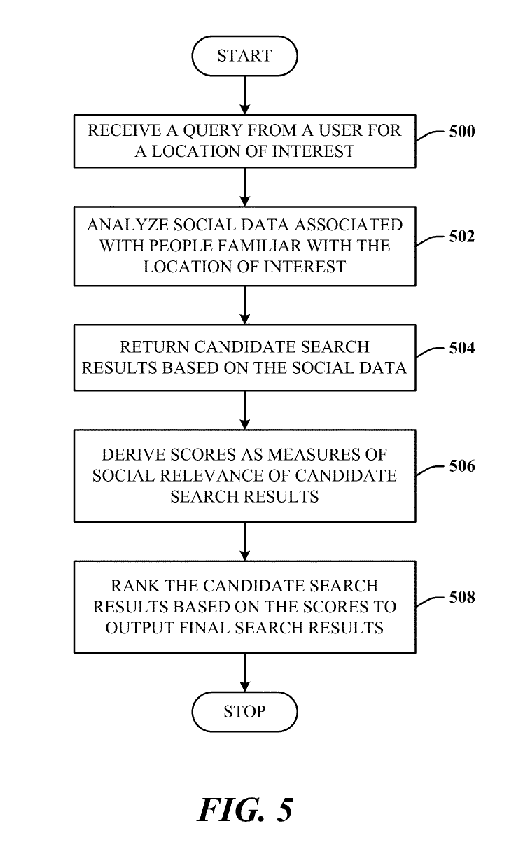

FIG. 5 illustrates an alternative method in accordance with the disclosed architecture. At 500, a query is received from a user for a location of interest. The user may be querying for a specific business or category of business. At 502, social data associated with people familiar with the location of interest, is analyzed. The social data can be user profiles, postings, and comments made as members of online social networks, for example. At 504, candidate search results are returned based on the social data. At 506, scores are derived as a measure of social relevance of the candidate search results. At 508, the candidate search results are ranked based on the scores to output final search results.

The method can further comprise deriving the scores based on postings related to the location of interest, content of the postings, and type of people socially related to a user, for example. The method can further comprise combining the social relevance of multiple users and trend data to derive the scores.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

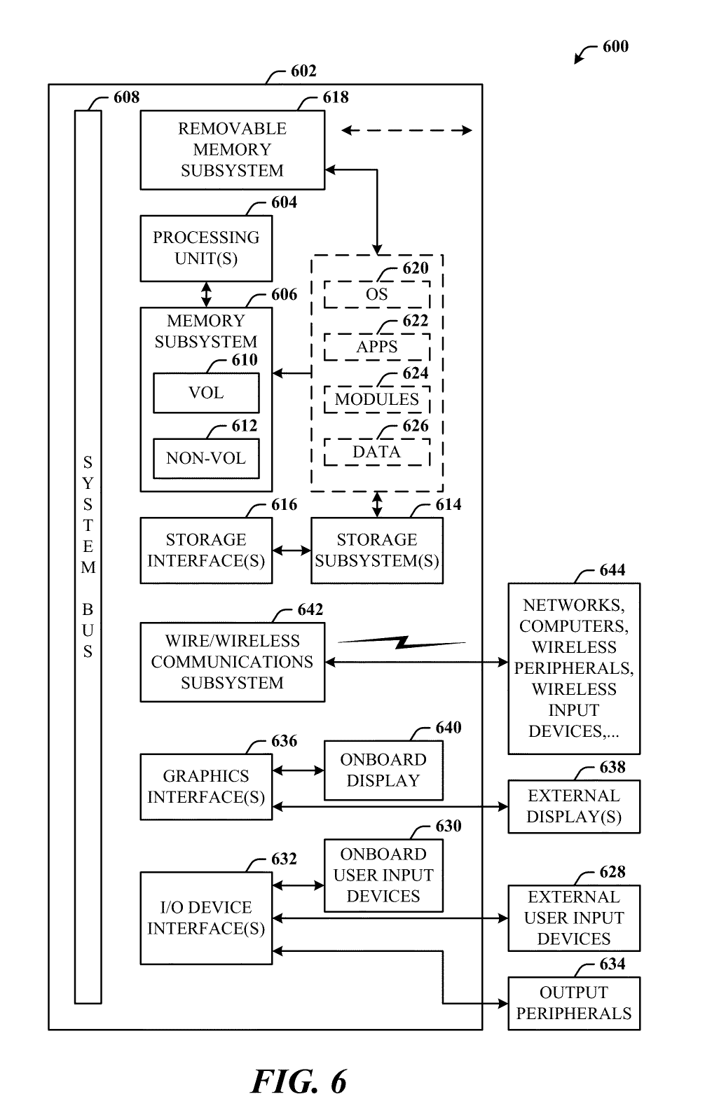

Referring now to FIG. 6, there is illustrated a block diagram of a computing system 600 that can utilize social relevance to infer information about points of interest in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 6 and the following description are intended to provide a brief, general description of the suitable computing system 600 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 600 for implementing various aspects includes the computer 602 having processing unit(s) 604, a computer-readable storage such as a system memory 606, and a system bus 608. The processing unit(s) 604 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 606 can include computer-readable storage (physical storage media) such as a volatile (VOL) memory 610 (e.g., random access memory (RAM)) and non-volatile memory (NON-VOL) 612 (e.g., ROM, EPROM, EEPROM, etc.). A basic input/output system (BIOS) can be stored in the non-volatile memory 612, and includes the basic routines that facilitate the communication of data and signals between components within the computer 602, such as during startup. The volatile memory 610 can also include a high-speed RAM such as static RAM for caching data.

The system bus 608 provides an interface for system components including, but not limited to, the system memory 606 to the processing unit(s) 604. The system bus 608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 602 further includes machine readable storage subsystem(s) 614 and storage interface(s) 616 for interfacing the storage subsystem(s) 614 to the system bus 608 and other desired computer components. The storage subsystem(s) 614 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 616 can include interface technologies such as EIDE, ATA, SATA, and IEEE 1394, for example.

One or more programs and data can be stored in the memory subsystem 606, a machine readable and removable memory subsystem 618 (e.g., flash drive form factor technology), and/or the storage subsystem(s) 614 (e.g., optical, magnetic, solid state), including an operating system 620, one or more application programs 622, other program modules 624, and program data 626.

The operating system 620, one or more application programs 622, other program modules 624, and/or program data 626 can include entities and components of the system 100 of FIG. 1, entities and components of the system 200 of FIG. 2, entities and components of the screenshot 300 of FIG. 3, and the methods represented by the flowcharts of FIGS. 4 and 5, for example.

Generally, programs include routines, methods, data structures, other software components, etc., that perform particular tasks or implement particular abstract data types. All or portions of the operating system 620, applications 622, modules 624, and/or data 626 can also be cached in memory such as the volatile memory 610, for example. It is to be appreciated that the disclosed architecture can be implemented with various commercially available operating systems or combinations of operating systems (e.g., as virtual machines).

The storage subsystem(s) 614 and memory subsystems (606 and 618) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media which does not employ propagated signals, can be accessed by the computer 602, and includes volatile and non-volatile internal and/or external media that is removable or non-removable. For the computer 602, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 602, programs, and data using external user input devices 628 such as a keyboard and a mouse, as well as by voice commands facilitated by speech recognition. Other external user input devices 628 can include a microphone, an IR (infrared) remote control, a joystick, a game pad, camera recognition systems, a stylus pen, touch screen, gesture systems (e.g., eye movement, head movement, etc.), and/or the like. The user can interact with the computer 602, programs, and data using onboard user input devices 630 such a touchpad, microphone, keyboard, etc., where the computer 602 is a portable computer, for example.

These and other input devices are connected to the processing unit(s) 604 through input/output (I/O) device interface(s) 632 via the system bus 608, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 632 also facilitate the use of output peripherals 634 such as printers, audio devices, camera devices, and so on, such as a sound card and/or onboard audio processing capability.

One or more graphics interface(s) 636 (also commonly referred to as a graphics processing unit (GPU)) provide graphics and video signals between the computer 602 and external display(s) 638 (e.g., LCD, plasma) and/or onboard displays 640 (e.g., for portable computer). The graphics interface(s) 636 can also be manufactured as part of the computer system board.

The computer 602 can operate in a networked environment (e.g., IP-based) using logical connections via a wired/wireless communications subsystem 642 to one or more networks and/or other computers. The other computers can include workstations, servers, routers, personal computers, microprocessor-based entertainment appliances, peer devices or other common network nodes, and typically include many or all of the elements described relative to the computer 602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 602 connects to the network via a wired/wireless communication subsystem 642 (e.g., a network interface adapter, onboard transceiver subsystem, etc.) to communicate with wired/wireless networks, wired/wireless printers, wired/wireless input devices 644, and so on. The computer 602 can include a modem or other means for establishing communications over the network. In a networked environment, programs and data relative to the computer 602 can be stored in the remote memory/storage device, as is associated with a distributed system. It will be appreciated that the network connections shown are exemplary and other means of establishing a communications link between the computers can be used.

The computer 602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a relevance component that computes relevance of a point of interest based on social relevance data derived from analysis of one or more people having an association with the point of interest, the point of interest part of candidate search results that are filtered and ranked to obtain final search results based in part on the social relevance data; and
a microprocessor that executes computer-executable instructions stored in a memory.

2. The system of claim 1, wherein the social relevance data is computed based on analysis of postings of the one or more people, content of the postings, and type of people socially related to a user.

3. The system of claim 1, wherein the relevance is computed based on an aggregation of the social relevance data of each of multiple people having visited or currently visiting the point of interest.

4. The system of claim 1, wherein the social relevance data is validated based on cross-referencing of physical distance data that includes at least one of geolocation data, check-in data, temporal data, or data mining.

5. The system of claim 1, wherein the social relevance data is employed to make a prediction of an event that will occur at a point in time.

6. The system of claim 1, wherein the social relevance data is processed to augment a final search result with information.

7. The system of claim 1, wherein the relevance component restricts computation of the social relevance data to friends of a user or computation of the social relevance data to determine new friends of the user.

8. The system of claim 1, wherein the social relevance data is processed in combination with another measure of relevance to rank the candidate search results.

9. The system of claim 1, wherein the social relevance data is computed as combined relevances obtained from other networks.

10. The system of claim 1, wherein the social relevance data is obtained from an external social network.

11. A method, comprising acts of:
receiving a query related to a point of interest;
analyzing people familiar with the point of interest to derive social relevance data;
computing relevance of search results related to the point of interest as candidate search results based on the social relevance data;
ranking the candidate search results to output final search results based on the relevance; and
utilizing a microprocessor that executes instructions stored in a memory.

12. The method of claim 11, further comprising computing the social relevance data based on postings related to the point of interest, content of the postings, and type of the people.

13. The method of claim 11, further comprising computing the social relevance data as an aggregation of the social relevance data of each of multiple users visiting the point of interest.

14. The method of claim 11, further comprising validating the social relevance data based on cross-referencing of physical distance data that includes at least one of geolocation data, check-in data, temporal data, or text mining.

15. The method of claim 11, further comprising processing the social relevance data in combination with another measure of relevance to rank the candidate search results.

16. The method of claim 11, further comprising computing the social relevance data as combined relevance information obtained from other networks.

17. The method of claim 11, further comprising obtaining the social relevance data from an external network.

18. A method, comprising acts of:
receiving a query from a user for a location of interest;
analyzing social data associated with people familiar with the location of interest;
returning candidate search results based on the social data;
deriving scores as measures of social relevance of candidate search results;
ranking the candidate search results based on the scores to output final search results; and
utilizing a microprocessor that executes instructions stored in a memory.

19. The method of claim 18, further comprising deriving the scores based on postings related to the location of interest, content of the postings, and type of people socially related to the user.

20. The method of claim 18, further comprising combining the social relevance of multiple users and trend data to derive the scores.
